(19) United States
(12) Patent Application Publication
(10) Pub. No.: US 2026/0299565 A1
(43) Pub. Date: Oct. 1, 2026

(54) PROCESS TUNING SYSTEM FOR SUBSTRATE PROCESSING SYSTEMS

(71) Applicant: LAM RESEARCH CORPORATION, Fremont, CA (US)

(72) Inventors: Behzad LAJEVARDI, San Ramon, CA (US); Tom TRINH, Dublin, CA (US); Willie KU, Fremont, CA (US); Hai DIEP, San Jose, CA (US); Ales JANHAR, Danville, CA (US); Chung-Ho HUANG, San Jose, CA (US); Travis Joseph WONG, Oakland, CA (US); John VALCORE, Worthington, OH (US)

(21) Appl. No.: 19/477,841

(22) PCT Filed: Apr. 17, 2024
(86) PCT No.: PCT/US2024/024951

§ 371 Date: Oct. 23, 2025

Related U.S. Application Data
(60) Provisional application No. 63/463,504, filed on May 2, 2023.

(51) Int. Cl. G05B 19/418

(52) U.S. Cl. CPC G05B 19/41865; G05B 19/4185; G05B 2219/32128; G05B 2219/45031

(57) ABSTRACT

A system for tuning a process performed on a substrate in a process module includes a first controller to provide steps to perform the process, a plurality of devices of the process module connected to a first network and to perform operations associated with the process, and a second controller including an interface and a processor. The interface receives selected inputs indicative of the operations of the devices from the devices via the first network and provides selected outputs to the devices via the first network to tune the process. The processor is configured to execute instructions to define the interface, process the selected inputs received during a step of the process, and generate the selected outputs based on the processed selected inputs to adjust one or more of the operations of one or more of the plurality of devices to tune the process during the step of the process.

### CROSS-REFERENCE TO RELATED APPLICATIONS

This application claims the benefit of U.S. Provisional Application No. 63/463,504, filed on May 2, 2023. The entire disclosure of the application referenced above is incorporated herein by reference.

### FIELD

The present disclosure relates generally to substrate processing systems and more particularly to a process tuning system for substrate processing systems.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Substrate processing systems (also called tools) are used to treat substrates such as semiconductor wafers. A substrate processing system comprises a processing chamber. The processing chamber comprises a plurality of process modules (also called stations). Each process module can process a substrate. For example, the processing may include deposition, etching, cleaning, and/or other substrate treatments. During processing, the substrate is arranged on a substrate support in the process module. A gas delivery system introduces one or more gases and vaporized precursors into the process module via a gas delivery device. For example, the gas delivery device can be a showerhead, an injector, and so on. In some processes, plasma may be used to initiate chemical reactions.

### SUMMARY

A system for tuning a process performed on a substrate in a process module of a substrate processing system comprises a first controller, a plurality of devices of the process module, and a second controller. The first controller is connected to the process module of the substrate processing system. The first controller is configured to provide steps to perform the process on the substrate in the process module. The plurality of devices of the process module is connected to a first network associated with the process module. The plurality of devices is configured to perform operations associated with the process. The second controller is connected to the process module. The second controller comprises an interface and a processor. The interface is configured to receive selected inputs from the plurality of devices via the first network and to provide selected outputs to the plurality of devices via the first network to tune the process. The selected inputs are indicative of the operations of the plurality of devices. The processor is configured to execute instructions to define the interface, process the selected inputs received during a step of the process, and generate the selected outputs based on the processed selected inputs to adjust one or more of the operations of one or more of the plurality of devices to tune the process during the step of the process.

In additional features, the first controller is configured to provide a graphical user interface to select the inputs and outputs of the interface.

In additional features, the first controller is configured to execute a first application or a second application to provide the steps to perform the process on the substrate in the process module. The instructions executed by the processor of the second controller to tune the process during the step of the process is independent of the first and second applications.

In additional features, the instructions comprise a first set of instructions and a second set of instructions. The processor of the second controller is configured to execute the first and second sets of instructions interchangeably to tune the process during the step of the process.

In additional features, the first controller is configured to execute an application to provide the steps to perform the process on the substrate in the process module. The second controller is configured to swap the instructions with another set of instructions to tune the process during the step of the process while the first controller executes the application unchanged.

In additional features, the system further comprises a master device connected to the first controller and the first network. The master device is configured to receive the selected inputs via the first network, receive the selected outputs from the interface, and transmit the selected outputs to the plurality of devices via the first network.

In additional features, the master device comprises a physical layer and a data link layer of the Open Systems Interconnection (OSI) model. The processor of the second controller is configured to execute the instructions in a network layer of the OSI model.

In additional features, the first controller is configured to execute an application in an application layer of the OSI model to provide the steps to perform the process. The processor of the second controller does not execute the instructions in the application layer.

In additional features, the plurality of devices comprises sensors and actuators associated with the process module. The sensors are configured to sense parameters associated with the process. The actuators are configured to perform the operations associated with the process.

In additional features, the instructions comprise a plurality of models for tuning the process, and when the instructions are executed by the processor of the second controller, the second controller is configured to adjust the one or more of the operations of the one or more of the plurality of devices using a first model of the plurality of models during the step of the process. The second controller is configured to receive from the plurality of devices, after the adjustment, a second set of the selected inputs via the first network during the step of the process, the second set of the selected inputs is indicative of the operations of the plurality of devices after the adjustment. The second controller is configured to adjust, based on the second set of the selected inputs, the one or more of the operations of the one or more of the plurality of devices using a second model of the plurality of models during the step of the process.

In additional features, the processor of the second controller is configured to communicate an endpoint of the step of the process to the first controller via the interface. The first controller is configured to advance the process to a next step of the process or end the process in response to the communicated endpoint.

In additional features, the second controller comprises a second interface. The processor of the second controller is configured to communicate an endpoint of the step of the process to the first controller via the serial interface. The first controller is configured to advance the process to a next step of the process or end the process in response to the communicated endpoint.

In additional features, the second interface comprises a serial interface.

In additional features, the second interface comprises a universal serial bus (USB) interface.

In additional features, the system further comprises a second network. The second controller and the plurality of devices are connected to the second network. The processor of the second controller is configured to receive additional data from the plurality of devices via the second network, process the additional data, and generate the selected outputs based on the processed additional data.

In additional features, the processor of the second controller is configured to receive the additional data comprising bursts of compressed data from the plurality of devices via a User Datagram Protocol (UDP) of a transport layer of the Open Systems Interconnection (OSI) model.

In additional features, the instructions comprise a plurality of models for tuning the process, and when the instructions are executed by the processor of the second controller, the second controller is configured to adjust the one or more of the operations of the one or more of the plurality of devices using a first model of the plurality of models during the step of the process. The second controller is configured to receive from the plurality of devices, after the adjustment, a second set of the selected inputs via the first network and a second set of the additional data via the second network during the step of the process, the second sets of the selected inputs and the additional data indicative of the operations of the plurality of devices after the adjustment. The second controller is configured to adjust, based on the second sets of the selected inputs and the additional data, the one or more of the operations of the one or more of the plurality of devices using a second model of the plurality of models during the step of the process.

In additional features, the interface comprises a physical layer and a data link layer of the Open Systems Interconnection (OSI) model. The processor of the second controller is configured to execute a first portion of the instructions associated with the first network in a network layer of the OSI model and a second portion of the instructions associated with the second network in a transport layer of the OSI model.

In additional features, one of the plurality of devices comprises a radio frequency (RF) power source and a matching circuit configured to supply RF power to the process module to generate plasma in the process module during the process. One of the selected outputs adjusts a frequency of the RF power source to adjust a profile of the plasma during the step of the process.

In additional features, one of the plurality of devices comprises a radio frequency (RF) power source and a matching circuit configured to supply RF power to the process module to generate plasma in the process module during the process. One of the selected outputs adjusts a frequency of the RF power source to adjust a profile of the plasma during the step of the process and to match the frequency in a second process module of the substrate processing system during the step of the process performed in the second process module.

In additional features, one of the plurality of devices comprises a temperature control device configured to control a temperature of a component of the process module during the step of the process. One of the selected outputs adjusts the temperature of the component during the step of the process.

In additional features, the temperature control device comprises a temperature controller, one or more heaters disposed in at least one of a substrate support and a showerhead of the process module, and one or more cooling channels disposed in at least one of the substrate support and the showerhead of the process module. The component comprises at least one of the substrate support and the showerhead of the process module.

In additional features, one of the plurality of devices comprises a mass flow controller configured to control a flow rate of a gas supplied to the process module during the process. One of the selected outputs adjusts the flow rate of the gas during the step of the process.

In additional features, one of the plurality of devices comprises a pressure controller configured to control a pressure of a gas supplied to the process module during the process. One of the selected outputs adjusts the pressure of the gas during the step of the process.

In additional features, one of the plurality of devices comprises a tunable edge ring system configured to adjust a shape of plasma around edges of the substrate during the process. One of the selected outputs adjusts the tunable edge ring system during the step of the process.

In additional features, adjusting the tunable edge ring system comprises adjusting an actuator associated with the tunable edge ring system, adjusting a radio frequency power supplied to the tunable edge ring system, or both.

In additional features, adjusting the tunable edge ring system comprises adjusting a radio frequency (RF) power supplied to the tunable edge ring system based on RF power supplied to the process module to generate the plasma in the process module during the process.

In additional features, the first and second controllers are implemented by first and second processor cores, respectively.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows an example of a substrate processing system;

FIG. 2 shows an example of a process module of the substrate processing system of FIG. 1;

FIG. 3 shows the Open Systems Interconnection (OSI) model for computer networks utilized by an embedded tuning system implemented in the process module of FIG. 2 to tune a process in the process module according to the present disclosure;

FIGS. 4A-7B show a first example of an embedded tuning system implemented in the process module of FIG. 2 to tune a process in the process module according to the present disclosure;

FIGS. 8A-11B show a second example of an embedded tuning system implemented in the process module of FIG. 2 to tune a process in the process module according to the present disclosure; and

FIGS. 12-15 show various methods performed by the embedded tuning systems of FIGS. 4A-11B to tune a process in the process module of FIG. 2 according to the present disclosure.

In the drawings, reference numbers may be reused to identify similar and/or identical elements.

### DETAILED DESCRIPTION

Tuning of a process is often performed to achieve expected process results, to recover from error modes, and/or to perform maintenance operations. Tuning comprises modifications/changes to operational parameters of various devices and subsystems of a process module that perform a process in the process module, in addition to adjustments to process parameters as explained below in detail. In some processes (e.g., deposition and etching processes), one or more process parameters (also called setpoints) can be tuned by inspecting processed substrates. Non-limiting examples of the parameters comprise temperatures of heaters used in a pedestal and a showerhead of a process module, flow rates, pressures, and temperatures of one or more gases supplied to the process module, coolant supply to the pedestal and the showerhead, radio frequency (RF) power supplied to strike plasma in the process module, and so on. For example, a metrology system can be used to inspect the processed substrate and provide feedback to a tuning system that is typically external to the tool. The external tuning system then tunes one or more parameters of the process to improve processing of a next substrate. Thus, the external tuning system operates on a per substrate basis. That is, after one substrate is processed, the results of the processed substrate are sent to the external tuning system to modify one or more setpoints of the process for processing a next substate in the process module.

Conventional tuning systems operate based on feedback received after inspecting a processed substrate. A conventional external tuning system cannot adjust the process parameters during substrate processing (i.e., while the substrate is being treated using the process recipe). Further, the feedback mechanism used by the conventional external tuning system to modify the setpoints of the process is slow and takes time. Furthermore, the conventional external tuning system comprises a dedicated application that cannot easily be exchanged with another application without also making changes to a process control system used in the process module to execute and control the process in the process module.

The present disclosure solves the above problems by providing a portable, plug and play tuning system that is built into or embedded in the process module. The embedded tuning system is not implemented in a process controller of the process module. Instead, the embedded tuning system is implemented external to the process controller in a separate controller in the process module. Specifically, the traditional tuning systems operate at application level (i.e., that are implemented in the application layer of the Open Systems Interconnection or OSI model). Unlike the traditional tuning systems, the embedded tuning system operates at (i.e., is implemented in) one or more lower layers than the application layer of the OSI model. Specifically, the embedded tuning system operates at (i.e., is implemented in) the network layer and/or the transport layer of the OSI model. As a result, unlike the traditional tuning systems, the embedded tuning system not only shortens the time taken to monitor and tune a process but can also monitor and tune the process during substrate processing. Specifically, the embedded tuning system can tune every step of a process in real time.

Further, since the embedded tuning system is implemented in one or more layers lower than the application layer of the OSI model, the embedded tuning system is also application agnostic. That is, the embedded tuning system allows a user (e.g., a tool operator) to exchange one tuning application with another tuning application in the embedded tuning system without requiring changes to the external tuning system or to a process control application executed by the process controller in the process module. The embedded tuning system also provides a unified interface that allows the user to select inputs and outputs of various devices (e.g., RF power supply and matching circuit, MFCs, pressure controllers, heaters, etc.) of the process module with which the embedded tuning system can interact. Using the unified interface, the embedded tuning system can provide feedback during execution of the same process step within time periods as low as 1 ms. The embedded tuning system also comprises one or more hot-swappable models so that one model used to tune a process parameter can be swapped with another model during the same process step. These and other features of the present disclosure are described below in detail.

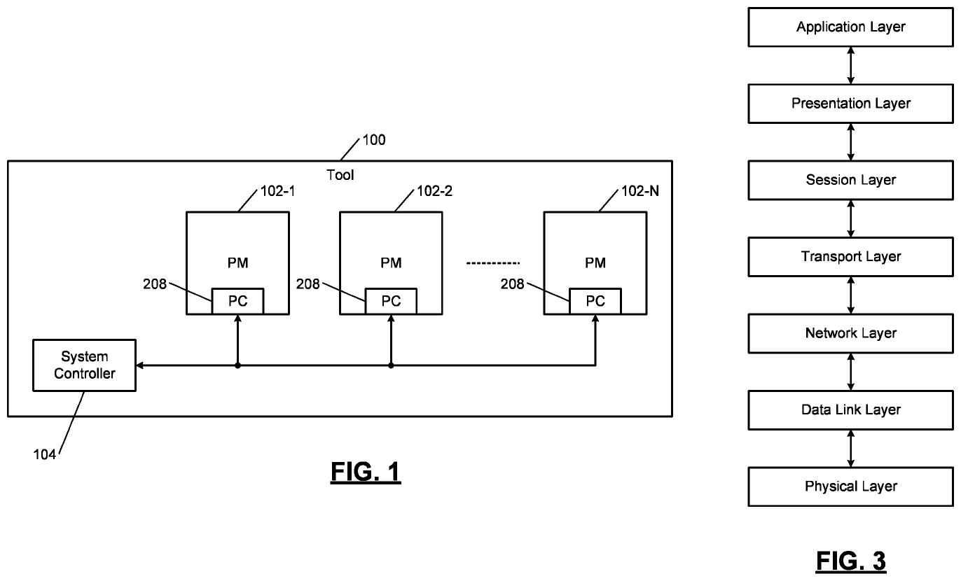

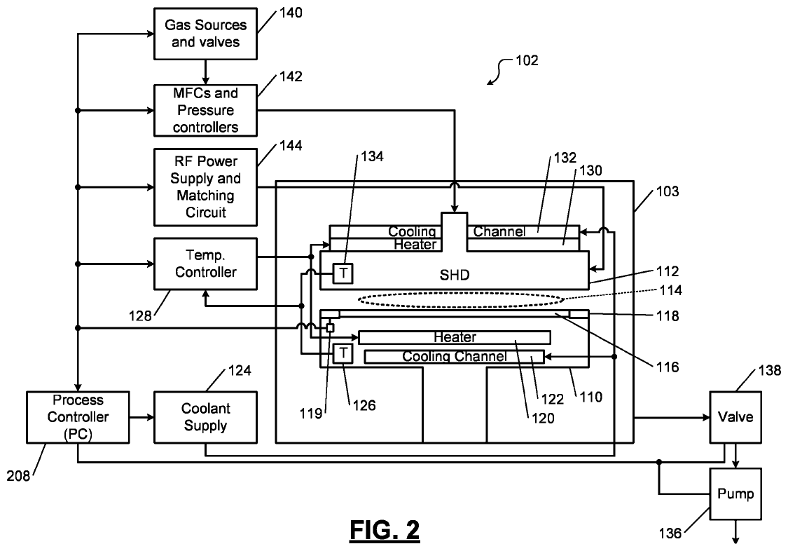

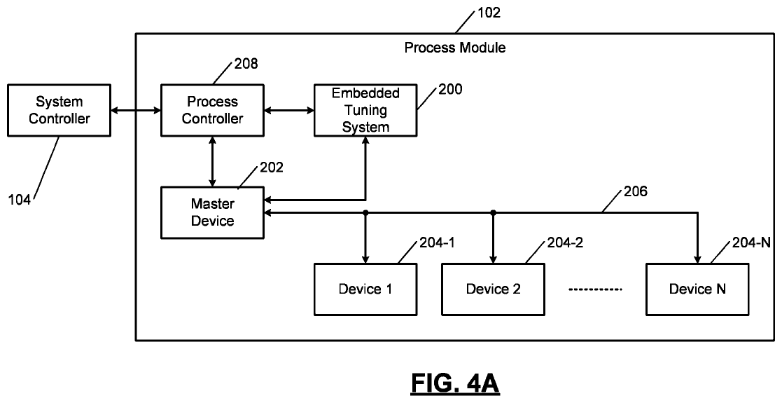

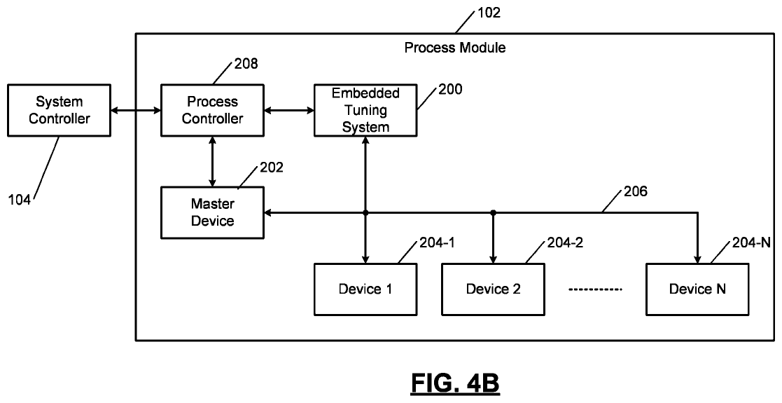

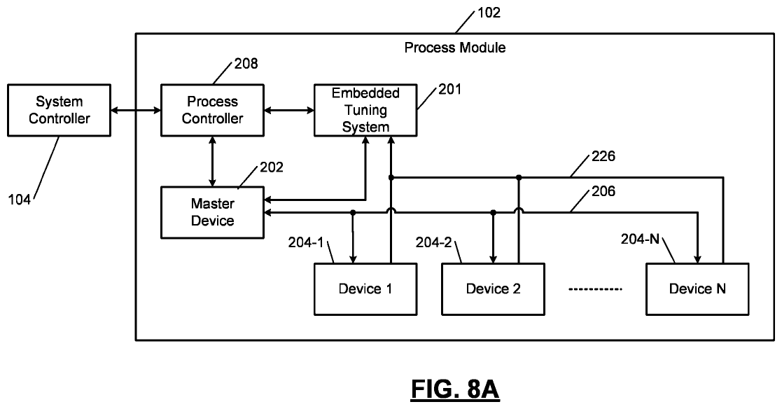

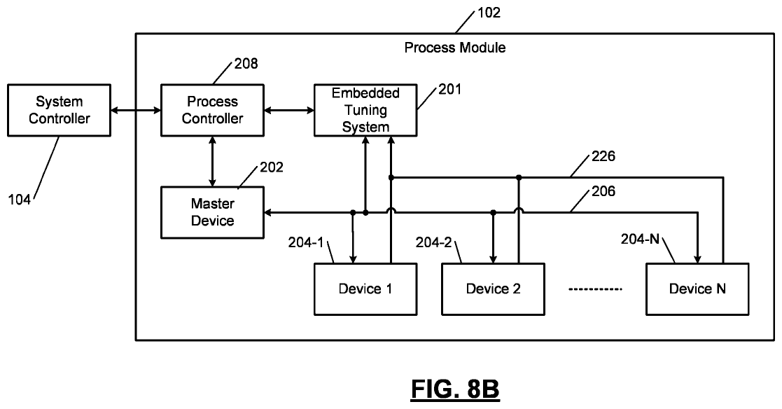

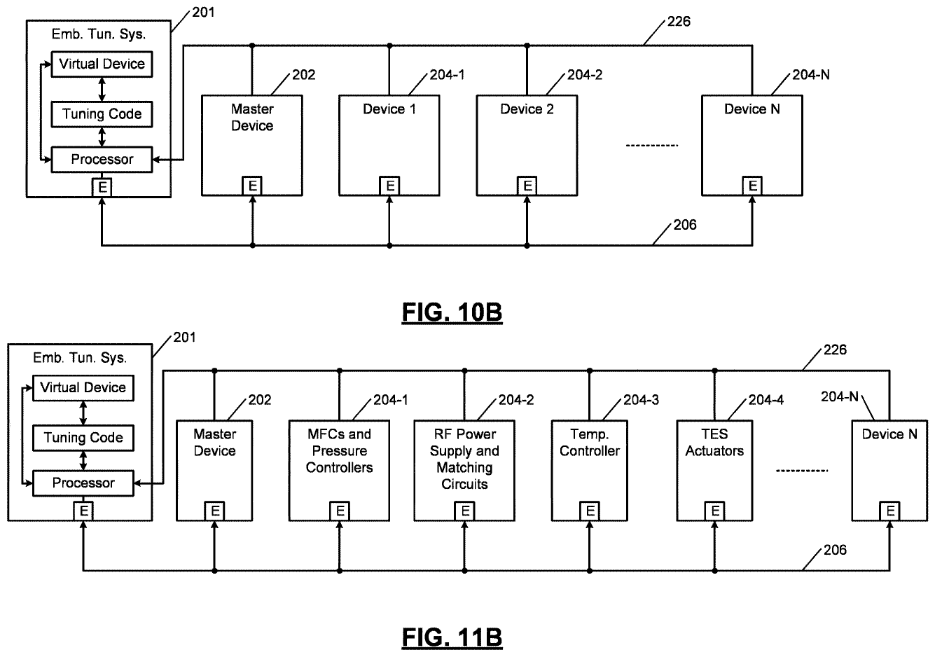

The present disclosure is organized as follows. In Sections 1 and 2, examples of a substrate processing system and a process module are shown and described with reference to FIGS. 1 and 2. In Section 3, before describing the embedded tuning system of the present disclosure, the Open Systems Interconnection (OSI) model is shown and described with reference to FIG. 3. In Section 4, a first example of the embedded tuning system is shown and escribed with reference to FIGS. 4A-7B. In Section 5, a second example of the embedded tuning system is shown and escribed with reference to FIGS. 8A-11B. In Section 6, examples of applications in which the embedded tuning system can be used to tune various subsystems and devices of a process modules are described. In Section 7, various methods of process tuning performed by the embedded tuning system of FIGS. 4A-11B are shown and described with reference to FIGS. 12-15.

### Section 1: Example of Substrate Processing System

FIG. 1 shows an example of a substrate processing system (also called a tool) 100. For example, the tool 100 comprises a plurality of process modules (PMs) 102-1, 102-2, . . . , and 102-N, where N is a positive integer. (collectively called the process modules 102 and individually called the process module 102). An example of the process module 102 is shown and described in detail with reference to FIG. 2. Briefly, each process module 102 can process a substrate. For example, each process module 102 can process a respective substrate concurrently. Each process module 102 can perform the same process on the respective substrates concurrently. In some examples, the process modules 102 can process the same substrate sequentially. That is, a substrate can be processed initially in the process module 102-1, then in the process module 102-2, and so on. Each process module 102 can perform a different process on the substrate sequentially. Each process module 102 comprises a process controller 208 that executes a process control application to control a process being performed in the process module 102. The process controller 208 is described in further detail with reference to FIG. 2.

The tool 100 comprises a system controller 104. The system controller 104 communicates with the processor controller 208 of each process module 102. The system controller 104 controls the substrate processing in the process modules 102 via the process controllers 208 of the process modules 102. For example, the system controller 104 provides a graphical user interface (GUI) that a user (e.g., a tool operator) can use to control the substrate processing in the process modules 102. In some examples, the system controller 104 can communicate with an external tuning system (not shown). The system controller 104 may also communicate with a metrology system (not shown) that may be external to the tool 100 or that may be implemented in the tool 100. The metrology system can inspect substrates processed in the process modules 102 and provide results to the system controller 104.

The tool 100 also comprises additional subsystems and components that are shown and described with reference to FIG. 2. Some of the subsystems and components are shared between the process modules while others can be provided for each of the process modules 102. The system controller 104 controls the additional subsystems and components.

### Section 2: Example of Process Module

FIG. 2 shows an example of the process module 102 and the additional subsystems and components of the tool 100. The additional subsystems and components of the tool 100 described below are provided for each process module 102. For example, the process module 102 comprises a processing chamber 103, a substrate support 110 and a showerhead 112. For example, the substrate support 110 may comprise a pedestal or an electrostatic chuck (ESC). In the example shown, the substrate support 110 and the showerhead 112 are configured to generate a capacitively coupled plasma (CCP) 114. While not shown, in some examples, the process module 102 may comprise a plasma source arranged above a processing chamber that encloses the pedestal 110 and a gas distribution device analogous to the showerhead 112. The plasma source can generate an inductively coupled plasma (ICP) that is supplied to the processing chamber via the gas distribution device.

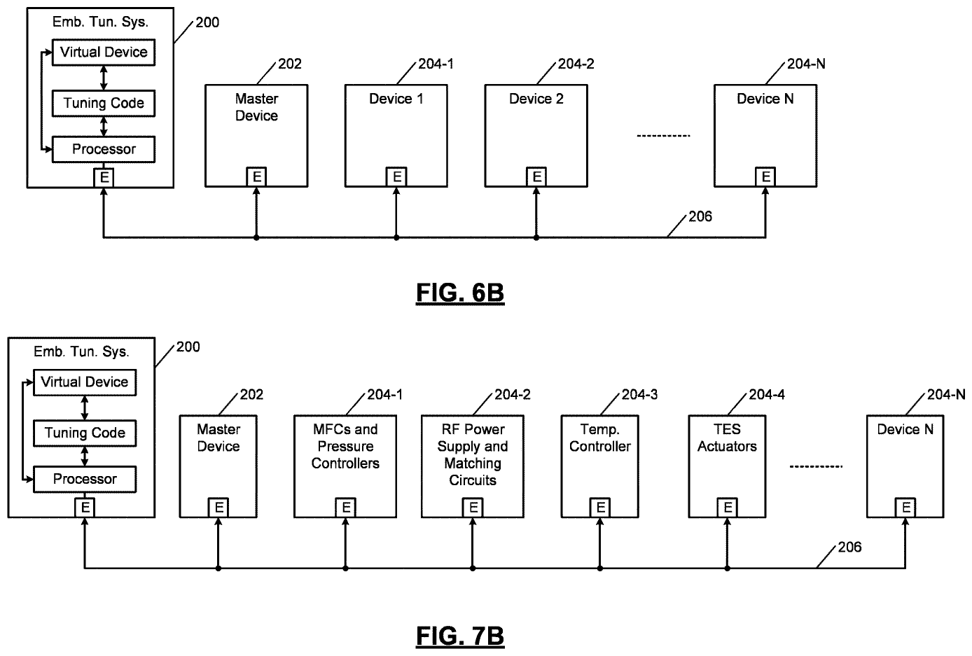

During processing, a substrate 116 is arranged on the substrate support 110. In some examples, an edge ring 118 is disposed on a periphery of a top surface of the substrate support 110. The edge ring 118 surrounds the substrate 116. A tunable edge sheath (TES) ring 119 is arranged under the edge ring 118. The TES ring 119 comprises an electrode that couples radio frequency (RF) power to the edge ring 118 to adjust the shape of the plasma 114 near the edges of the substrate 116. The RF power can be adjusted to improve process uniformity on the substrate 116. The TES ring 119 is moved relative to the edge ring 118 using TES actuators (now shown). The TES ring 119 and the associated actuators and the RF power supply can be collectively called a tunable edge ring system (e.g., element 204-4 shown in FIGS. 7 and 11, where tuning of setpoints or parameters of element 204-4 is described).

The substrate support 110 can comprise a heater 120 to heat the substrate 116. The substrate support 110 comprises a cooling channel 122. A coolant from a coolant supply 124 can be circulated through the cooling channel 122 to control the temperature of the substrate 116. The substrate support 110 comprises a temperature sensor 126 to sense the temperature of the substrate support 110. A temperature controller 128 controls power supplied to the heater 120 based on the feedback from the temperature sensor 126.

In some examples, the showerhead 112 can also comprise a heater 130 to heat gases supplied by the showerhead 112 to the process module 102. The showerhead 112 can also comprise a cooling channel 132. The coolant from the coolant supply 124 can be circulated through the cooling channel 132 to control the temperature of the showerhead 112. The showerhead 112 can also comprise a temperature sensor 134 to sense the temperature of the showerhead 112. The temperature controller 128 can control power supplied to the heater 130 based on the feedback from the temperature sensor 134. The temperature controller 12, the heaters 120, 130, and the cooling channels 122, 132 can be collectively called a temperature control device or subsystem (e.g., element 204-3 shown in FIGS. 7 and 11, where tuning of setpoints or parameters of element 204-3 is described).

The tool 100 further comprises a plurality of gas sources and valves collectively shown at 140 and a plurality of mass flow controllers (MFCs) and pressure controllers collectively shown at 142. For example, depending on the process being performed in the process module 102, the gas sources supply various gases through the valves and elements 142 to the process module 102. Non-limiting examples of the gases comprise process gases, precursors, vaporized precursors, purge gases, cleaning gases, and so on. The MFCs control flow rates of the gases supplied to the process module 102. The pressure controllers control pressure of the gases supplied to the process module 102. While not shown, the process module 102 may comprise pressure sensors that provide feedback to the pressure controllers. The MFC and pressure controllers 142 are shown as element 204-1 in FIGS. 7 and 11, where tuning of setpoints or parameters of element 204-1 is described.

The tool 100 further comprises an RF power supply and a matching circuit collectively shown at 144. For example, the RF power supply comprises an RF generator (also called an RF source) that generates RF power. In some examples, the RF power supply may comprise a high frequency (HF) RF generator that generates a high frequency RF signal and a low frequency (LF) RF generator that generates a low frequency RF signal. The matching circuit may comprise one or more impedance matching circuits that match the impedances of the RF power supply and the plasma 114. When the same process is performed on substrates in the process modules 102, the RF power supplies of each of the process modules 102 need to be matched (i.e., need to supply the same RF power for the substrates to be processed uniformly in each of the process modules 102. The RF power supply and matching circuit 144 are shown as element 204-2 in FIGS. 7 and 11, where tuning of setpoints or parameters of element 204-2 is described.

In addition, a pump 136 is connected to the processing chamber 103 via a valve 138. The pump 136 controls pressure (e.g., maintains vacuum) in the processing chamber 103 and evacuates gases and reaction by products from the processing chamber 103. The process controller 208 controls all the elements, components, and subsystems of the process modules 102 described above.

### Section 3: OSI Model

FIG. 3 shows the Open Systems Interconnection (OSI) model formulated by the International Organization for Standardization (ISO) for standardizing communications between systems using computer networking. The OSI model provides a standard that enables diverse communication systems to communicate with each other using standard protocols. The OSI model splits the communication into seven layers that are stacked on top of each other. Each layer of the OSI Model performs a specific function and communicates with the layers above and below the layer.

The OSI model comprises an application layer (layer 7), a presentation layer (layer 6), a session layer (layer 5), a transport layer (layer 4), a network layer (layer 3), a data link layer (layer 2), and a physical layer (layer 1). The application layer deals with software applications and is the highest layer while the physical layer deals with circuits and is the lowest layer. The following is a summary of the seven layers.

The application layer is used by end-user software applications that manage human-to-machine interactions by accessing network services through the lower layers. The application layer provides communication protocols that allow software applications to send and receive information and provide analyzed data to users. The presentation layer prepares and presents data in a usable format for the application layer. For example, the presentation layer defines the type of encoding, encryption, and compression used by devices so that data can be correctly exchanged between them. The presentation layer receives data from the application layer and prepares the data for transmission over the session layer.

The session layer maintains connections between devices and controls communication ports and sessions between the devices. The session layer creates communication channels called sessions between the devices. The session layer opens sessions between devices, keeps the sessions open and functional during data transfer between the devices, and closes the sessions when the communication between the devices ends. The session layer can also set checkpoints during a data transfer so that if a session between the devices fails or is interrupted, the devices can resume the data transfer from a last checkpoint.

The transport layer transmits data using transmission protocols. Non-limiting examples of the transmission protocols comprise transmission control protocol (TCP) and User Datagram Protocol (UDP). On transmit end, the transport layer splits data from the session layer into segments. On receive end, the transport layer reassembles the segments into data that can be used by the session layer. The transport layer performs flow control, which comprises sending data at a rate that matches a connection speed of the receiving device and vice versa. The transport layer also performs error control, which comprises checking if data was correctly received and requesting the sender to resend the data if the data was incorrectly received.

The network layer determines the physical path through which the data is transmitted and received. The network layer splits the segments into packets on the transmit end and reassembles the packets on the receive end. The network layer uses network addresses to route packets to a destination device through the best path across a network.

The data link layer forms and terminates a connection between two physically-connected devices on a network. The data link layer splits packets into frames and sends the frames from a source to a destination device. The data link layer comprises Logical Link Control (LLC) and Media Access Control (MAC). The LLC identifies network protocols and performs error checking and frame synchronization. The MAC uses MAC addresses to connect devices and define permissions for transmitting and receiving data between the devices. The physical layer transmits raw data (e.g., streams of 0 s and 1 s) over a communication medium (e.g., a cable, a wireless medium, etc.). The physical layer controls the physical cable or wireless connection between network nodes. The physical layer defines the connector, the electrical cable or wireless technology connecting the devices, and transmits and receives raw data while controlling bit rate.

Generally, an Ethernet for Control Automation Technology (EtherCAT) network is used to connect various devices and subsystems (collectively called the devices) of a process module to a master device of the EtherCAT network in the process module. Non-limiting examples of the devices comprise various sensors (e.g., temperature and pressure sensors), mass flow controllers, pressure controllers, RF power supply and matching circuit, and actuators used in the process module during substrate processing. Each of the master device and the devices comprises an Ethernet port or a network interface that connects the master device and the devices to the EtherCAT network. The master device and the devices can be connected to the EtherCAT network using any network topology (e.g., daisy chain, star, and so on).

The master device generates and sends a frame to the devices via the EtherCAT network and receives the frame back from the devices via the EtherCAT network and is therefore called the master device. Each frame originates from the master device and is returned to the master device via the EtherCAT network. The frame comprises datagrams that collect information from the devices and/or provide instructions to the devices. The master device collects the information provided by the devices in the frame. The master device provides the collected information to a process control system implemented in a process controller in the process module that controls a process being performed on a substrate in the process module.

Typically, an external tuning system communicates with the process control system implemented in the process controller 208 in the process module 102 (e.g., via the system controller 104 of the tool 100) and provides tuning data to tune the process based on results of a processed substrate collected from a metrology system. The embedded tuning system according to the present disclosure operates differently as described below.

### Section 4: First Example of Embedded Tuning System

FIGS. 4A-7B show a first example of the embedded tuning system according to the present disclosure. In FIGS. 4A and 4B, an embedded tuning system 200 is embedded in the process module 102. The process module 102 comprises the embedded tuning system 200, a master device 202, and a plurality of devices 204-1 (shown as Device 1), 204-2 (shown as Device 2), . . . , and 204-N (shown as Device N), where N is a positive integer (collectively called the devices 204 and individually called the device 204). In FIG. 4A, the master device 202 and the devices 204 are connected to an EtherCAT network 206. The master device 202 and the devices 204 communicate with each other via the EtherCAT network 206. The embedded tuning system 200 communicates with the master device 202. The embedded tuning system 200 communicates with the EtherCAT network 206 via the master device 202. In FIG. 4B, the embedded tuning system 200, the master device 202 and the devices 204 are connected to an EtherCAT network 206. The embedded tuning system 200, the master device 202 and the devices 204 communicate with each other via the EtherCAT network 206. In both FIGS. 4A and 4B, the embedded tuning system 200 communicates with the process controller 208 directly or via the master device 202.

Non-limiting examples of the devices 204 comprise various sensors (e.g., temperature and pressure sensors), mass flow controllers, pressure controllers, RF power supply and matching circuit, and actuators used in the process module 102 during substrate processing. The devices 204 and their examples are described below in detail with reference to FIGS. 7 and 8.

The process module 102 comprises the process controller 208. The process controller 208 implements a process control system or a process control application in the application layer of the OSI model to control a process being performed in the process module 102. For example, the application executed in the process controller 208 provides a recipe for the process being performed on the substrate 116 (shown in FIG. 1) in the process module 102. The process controller 208 communicates with the system controller 104 of the tool 100 (shown in FIG. 1), the embedded tuning system 200, and the master device 202.

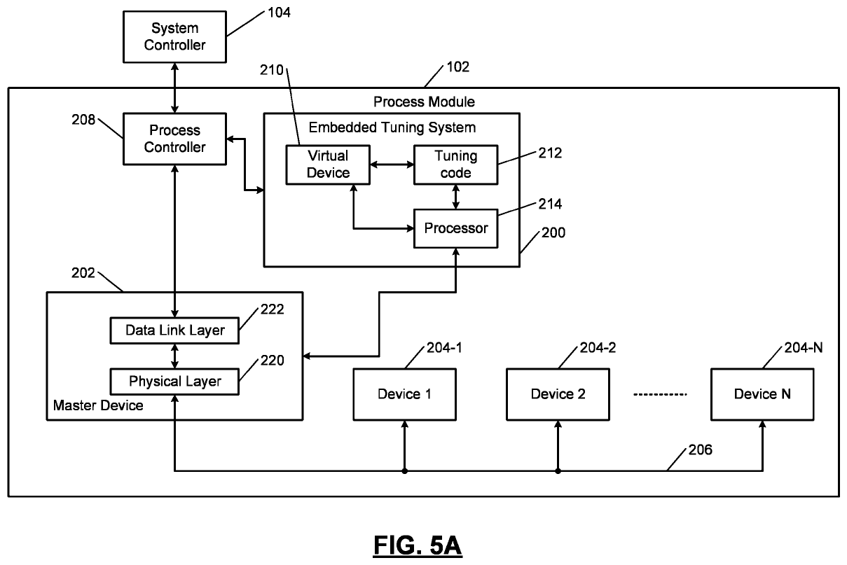

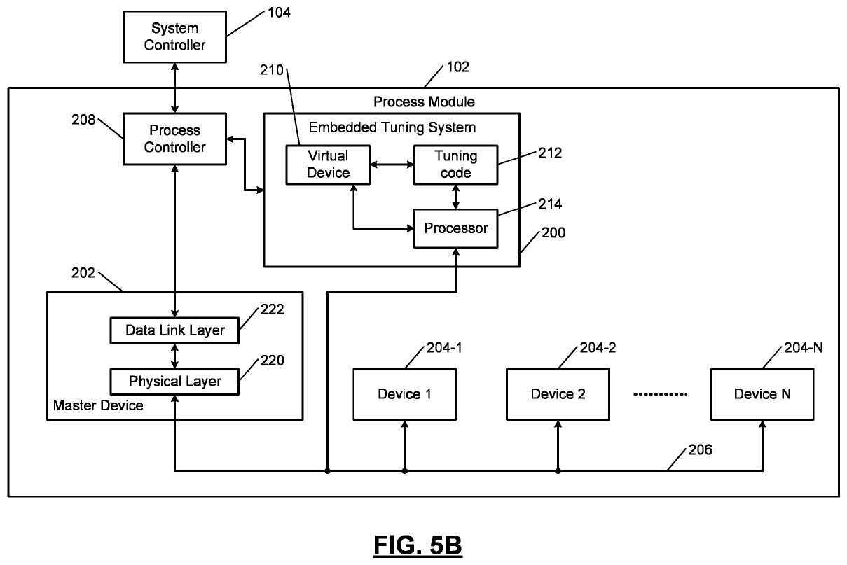

In some examples, the embedded tuning system 200, the master device 202, and the process controller 208 may be implemented on a single printed circuit board (PCB) of the process module 102. However, the embedded tuning system 200 is not implemented in the process controller 208. Instead, the embedded tuning system 200 is implemented external to the process controller 208. The embedded tuning system 200 is implemented in a separate controller in the process module 102 as shown in FIGS. 5A and 5B. The process controller 208 may be called a first controller and the separate controller in which the embedded tuning system 200 (or 201 described below) is implemented may be called a second controller. In some examples, the first and second controllers may be implemented by first and second processor cores, respectively. The process controller 208 does not tune the process being performed on the substrate 116 in the process module 102. Instead, the embedded tuning system 200 tunes the process being performed on the substrate 116 in the process module 102 as described below.

FIGS. 5A and 5B show the embedded tuning system 200 shown in FIGS. 4A and 4B, respectively, in detail. The embedded tuning system 200 comprises a virtual device 210, a tuning code (i.e., executable instructions or an executable image of a tuning program to tune the process) 212, and a processor 214 implemented in a controller in the process module 102. This controller is separate from the process controller 208. For example, the tuning code 212 may be stored in a memory of the controller. For example, the memory may comprise a rewritable memory (e.g., flash memory) in which the tuning code can be configured and reconfigured or downloaded according to the process being performed in the process module 102. The processor 214 executes the tuning code 212. The tuning code 212 may also be called a program code that comprises executable instructions that are executed by the processor 214.

The virtual device 210 communicates with the devices 204 of the process module 102 through the EtherCAT network 206 indirectly via the master device 202 of the process module 102 as shown in FIG. 5A or directly through the EtherCAT network 206 as shown in FIG. 5B. The virtual device 210 is so called because the virtual device 210 is not a physical device such as a sensor or an actuator. Instead, the virtual device 210 comprises an interface of selected inputs and outputs of the devices 204 of the process module 102 that are used to tune the process being performed on the substrate 116 in the process module 102. Using the tuning code 212, a user (e.g., an operator) can select the inputs and outputs of the devices 204, and the processor 214 can create the virtual device 210 (i.e., the processor 214 can define the interface using the selected inputs and outputs).

Generally, the master device 202 comprises only a physical layer 220 and a data link layer 222 of the OSI model shown in FIG. 3. The master device 202 does not comprise any higher layers of the OSI model shown in FIG. 3. Therefore, with only the physical and data link layers 220, 222, the master device 202 can only receive information from the devices 204 and deliver information to the devices 204 via the EtherCAT network 206. Accordingly, the master device 202 cannot determine by itself what information to deliver to the devices 204 to tune the process.

Typically, in the absence of the embedded tuning system 200, the master device 202 receives the information to adjust the setpoints of the devices 204 from the process control system implemented in the process controller 208, which in turn receives the information from the external tuning system, and the master device 202 simply delivers the information to the devices 204. In the absence of the embedded tuning system 200, the information to tune the process is generated by the external tuning system at the application layer level (i.e., in an external software application used to tune the process). The information is then provided to the process control system in the process controller 208 of the process module 102. The information then flows through the lower layers of the OSI model from the process control system in the process controller 208 to the master device 202, which delivers the information to the devices 204 through the physical and data link layers 220, 222 of the master device 202 via the EtherCAT network 206.

Instead, the embedded tuning system 200 of the present disclosure is implemented in a network layer that is added above the stack of the physical layer 220 and the data link layer 222 of the master device 202. The embedded tuning system 200 comprises the processor 214, memory storing the tuning code 212, and the virtual device 210. The virtual device 210 communicates with the devices 204 of the process module 102 via the EtherCAT network 206 indirectly via the master device 202 or directly as shown in FIGS. 5A and 5B. The virtual device 210 collects information (e.g., data from sensors and actuators of the process module 102) from the devices 204. The processor 214 and the tuning code 212 analyze the information and generate instructions (e.g., adjustments to setpoints) that the virtual device 210 outputs to the devices 204 to tune the parameters of the process. The virtual device 210 can receive information from the devices 204 via a frame sent by the devices 204 to the master device 202 and can output instructions via a frame sent to the devices 204 by the master device 202 to tune the process based on the received information. The methods performed by the embedded tuning system 200 to tune the process in the process module 102 are shown and described below in detail with reference to FIGS. 12-15. Thus, the embedded tuning system 200 can adjust one or more parameters of one or more devices 204 to tune the process by interacting with the devices 204 on the fly (i.e., in real time while the process is running). The embedded tuning system 200 can tune the process without involving the process control system implemented in the process controller 208 of the process module 102 and the external tuning system.

Thus, in the first example, the virtual device 210 implements a set of virtual sensors and actuators that do not use any hardware and that can enhance existing/real sensors and actuators in the devices 204 of the process module 102. An external tuning application can utilize the virtual inputs and outputs (IOs) of the virtual device 210 to provide tuning parameters while observing changes in the IOs in real time and can pass these tuning parameters through an EtherCAT interface to the process module 102 within time periods as short as 1 ms. The process module 102 can use these tuning parameters to modify the setpoints of the process steps in real time.

The virtual IOs from the virtual device 210 and the real IOs from the devices 204 in the process module 102 have the same presentation (e.g., format) to the process control application implemented in the process controller 208 in the process module 102. Accordingly, the tuning application (i.e., the tuning code 212) of the embedded tuning system 200 can be exchanged (i.e., swapped) with another tuning application (i.e., another tuning code 212) without affecting the process control application implemented in the process controller 208 in the process module 102 or the external tuning system. The user (e.g., the operator) of the tool 100 can develop, deploy, and maintain the tuning code 212 and the virtual device 210 of the embedded tuning system 200 based on a predefined interface. The number of the IOs defined in the virtual device 210 does not affect the bandwidth of EtherCAT frames transmitted to the real devices 204.

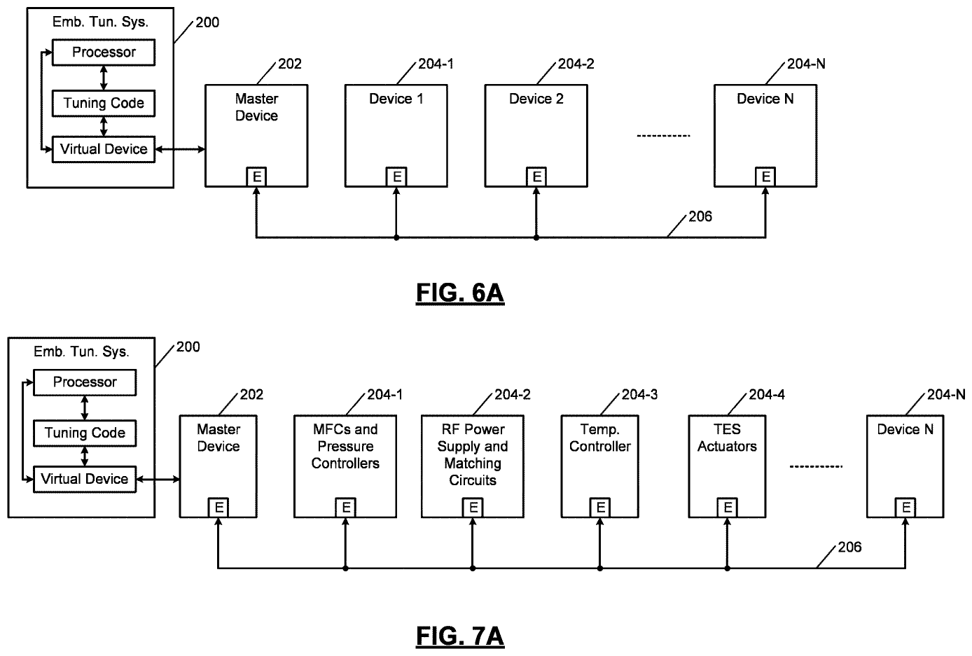

FIGS. 6A and 6B show an example of the connections of the embedded tuning system 200, the master device 202, and the devices 204 of the process module 102 to the EtherCAT network 206. FIGS. 6A and 6B correspond to FIGS. 5A and 5B, respectively. In FIG. 6A, each of the master device 202 and the devices 204 of the process module 102 comprises an Ethernet port or a network interface (shown as element “E”) that connects the master device 202 and the devices 204 of the process module 102 to the EtherCAT network 206. The master device 202 and the devices 204 of the process module 102 can be connected to the EtherCAT network 206 using any network topology (e.g., daisy chain, star, and so on). The embedded tuning system 200 communicates does not comprise an Ethernet port or a network interface to communicate directly with the EtherCAT network 206. Instead, the embedded tuning system 200 communicates with the master device 202 and communicates with the devices 204 of the process module 102 and the EtherCAT network 206 indirectly via the master device 202. In FIG. 6B, each of the embedded tuning system 200, the master device 202, and the devices 204 of the process module 102 comprises an Ethernet port or a network interface (shown as element “E”) that connects the embedded tuning system 200, the master device 202, and the devices 204 of the process module 102 to the EtherCAT network 206. The embedded tuning system 200, the master device 202, and the devices 204 of the process module 102 can be connected to the EtherCAT network 206 using any network topology (e.g., daisy chain, star, and so on).

In FIGS. 6A and 6B, the master device 202 sends a frame to the devices 204 and receives the frame back from the devices 204. The frame may comprise datagrams that collect information from the devices 204 and/or provide instructions (e.g., setpoints provided by the tuning code 212 and the virtual device 210 to tune the process) to the devices 204. The master device 202 collects the information provided by the devices 204 in the frame. The master device 202 provides the collected information to the process control system implemented in the process controller 208 in the process module 102 as well as to the embedded tuning system 200 that controls the process being performed on the substrate 116 in the process module 102. The methods performed by the embedded tuning system 200 to tune the process in the process module 102 are shown and described below in detail with reference to FIGS. 12-15.

FIGS. 7A and 7B show examples of the devices 204 shown in FIGS. 6A and 6B, respectively. For example, the device 204-1 may comprise element 142 shown in FIG. 2. That is, the device 204-1 may comprise the mass flow controllers (MFCs) that control flow rates of the gases supplied to the process module 102 during the process and pressure controllers that control pressures at which the gases are supplied to the process module 102 during the process. Based on the information collected by the master device 202 from the device 204-1, the tuning code 212 and the virtual device 210 can change the setpoints for the MFCs to adjust gas flow rates and the pressure controllers to adjust gas pressures to tune the process being performed on the substrate 116 in the process module 102.

For example, the device 204-2 may comprise element 144 shown in FIG. 2. That is, the device 204-2 may comprise the RF power supply and the matching circuit 144 used to supply RF power to generate the plasma 114 (shown in FIG. 2) in the process module 102. Based on the information collected by the master device 202 from the device 204-2, the tuning code 212 and the virtual device 210 can change the setpoints for the RF power supply (e.g., to adjust frequencies of the HF and LF power supplies) and the matching circuit (e.g., to adjust amounts by which to vary capacitances of capacitors in the matching circuit) to tune the plasma 114 in the process being performed on the substrate 116 in the process module 102.

For example, the device 204-3 may comprise element 128 shown in FIG. 2. That is, the device 204-3 may comprise the temperature controller 128 used to sense the temperatures (e.g., from the temperature sensors 126, 134), control the power supplied to the heaters 120, 130, and control the supply and flow of the coolant through the cooling channels 122, 132. Based on the information collected by the master device 202 from the device 204-3, the tuning code 212 and the virtual device 210 can change the setpoints for the temperature controller 128 (e.g., to adjust the power supplied to the heaters 120, 130, and to adjust the supply and flow of the coolant through the cooling channels 122, 132) to tune the process being performed on the substrate 116 in the process module 102.

For example, the device 204-4 may comprise TES actuators used to actuate the TES ring 119 (shown in FIG. 2) to adjust the shape of the plasma 114 near the edge of the substrate 116 during processing. Based on the information collected by the master device 202 from the device 204-4, the tuning code 212 and the virtual device 210 can change the setpoints for the TES actuators to adjust the extent of actuation of the TES ring 119. Thus, the shape of the plasma 114 near the edge of the substrate 116 can be adjusted during substrate processing to tune the process being performed on the substrate 116 in the process module 102.

### Section 5: Second Example of Embedded Tuning System

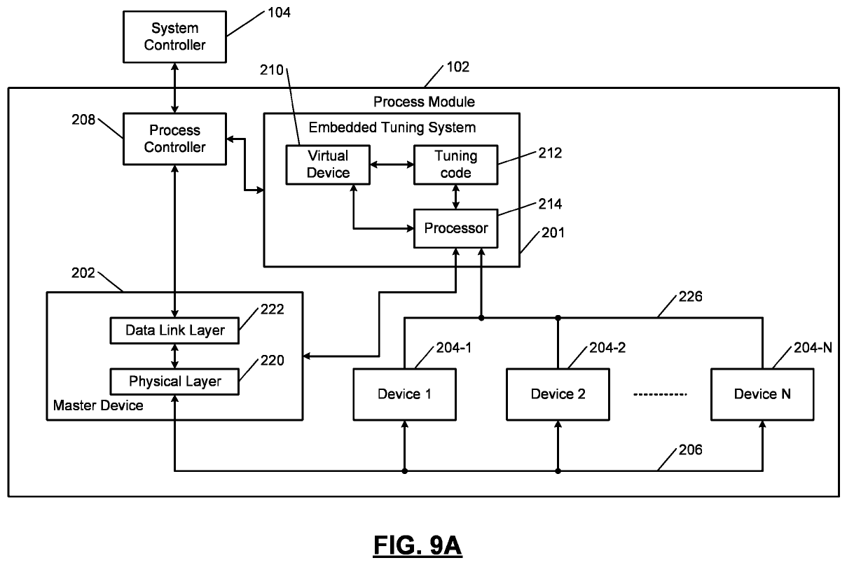

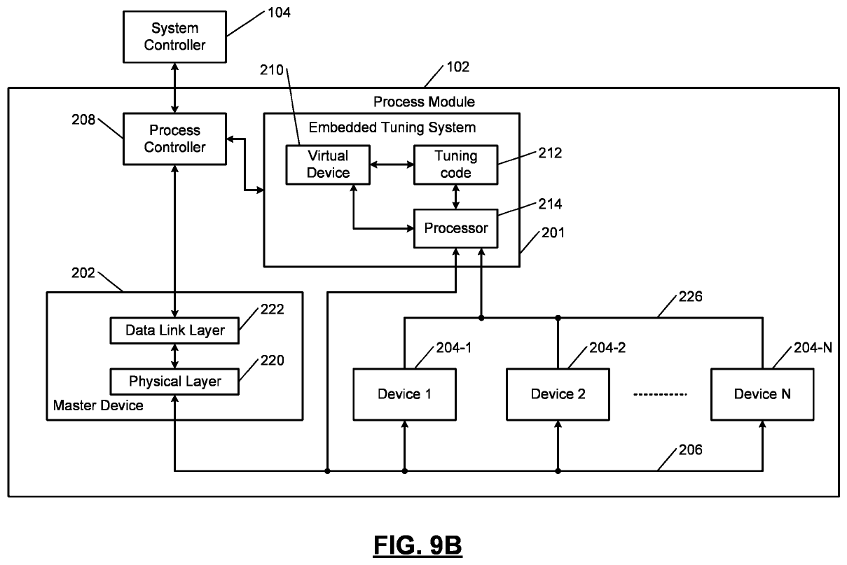

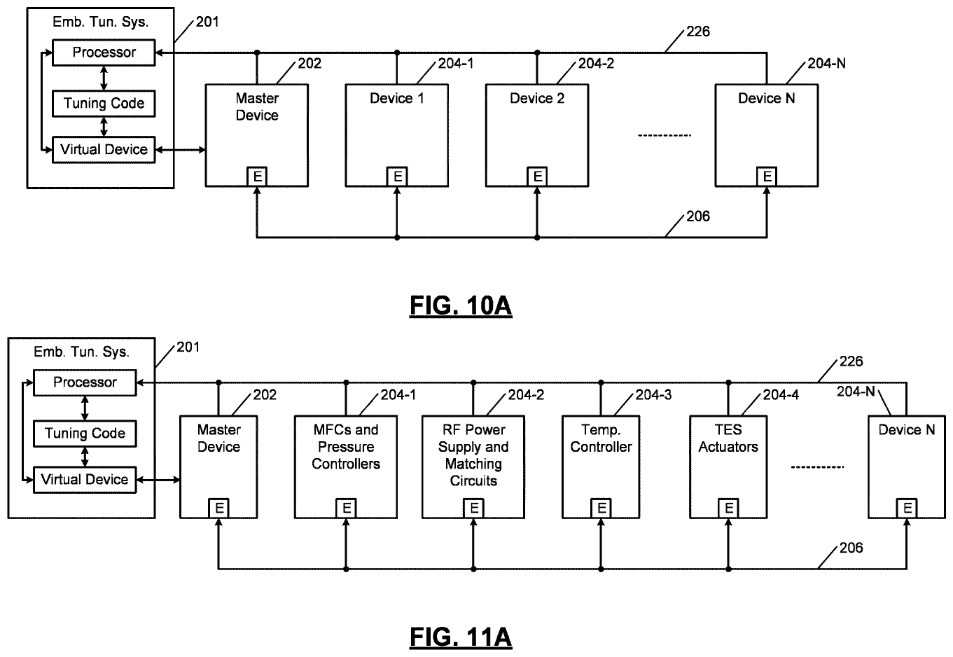

FIGS. 8A-11B show a second example of the embedded tuning system (i.e., an embedded tuning system 201) according to the present disclosure. In the second example, the embedded tuning system 201 comprises all of the elements of the embedded tuning system 200 described above with reference to 4A-7B and further comprises an additional sensing network 226 to monitor and sense data from the devices 204 as described below in detail. FIGS. 8A and 8B show the embedded tuning system 201 and the sensing network 226. FIGS. 9A and 9B show the embedded tuning system 201 in detail. FIGS. 10A and 10B show an example of the connections of the embedded tuning system 201, the master device 202, and the devices 204 of the process module 102 to the EtherCAT network 206 and the sensing network 226. FIGS. 11A and 11B show examples of the devices 204 and additional connections of the devices 204 to the embedded tuning system 201 via the sensing network 226.

The sensing network 226 is separate from the EtherCAT network 206. The sensing network 226 comprises an embedded EtherCAT network layer. In general, the EtherCAT network 206 may be called a first network and the sensing network 226 may be called a second network. Elements identified in FIGS. 8A-11B using the reference numerals as those used in FIGS. 4A-7B are already described above with reference to FIGS. 4A-7B and are therefore not described again for brevity.

The embedded tuning system 201 is implemented in a transport layer of the OSI model shown in FIG. 3 to take advantage of User Datagram Protocol (UDP) used in a transmission control protocol/internet protocol (TCP/IP) stack in the transport layer. The embedded tuning system 201 also comprises the processor 214, the memory storing the tuning code 212, and the virtual device 210. The processor 214 implements the sensing network 226 and processes data captured from the device 204 via the sensing network 226 using UDP. The embedded tuning system 201 captures data from the devices 204 via the sensing network 226 using UDP, the processor 214 processes the captured data, the tuning code 212 generates adjustments to setpoints for the devices 204 based on the processing. The virtual device 210 provides the setpoints to the master device 202, which outputs the adjustments via a frame sent to the devices 204 though the EtherCAT network 206.

As shown in FIGS. 8A-11B, in addition to communicating with the devices 204 via the EtherCAT network 206 as described above in the first example, the embedded tuning system 201 implements the sensing network 226 that is optimized for monitoring and sensing data from the devices 204 using UDP. The sensing network 226 can capture higher level (e.g., compressed) data from the devices 204 using UDP at higher speeds than the EtherCAT network 206. The embedded tuning system 201 can capture the compressed data in bursts from the devices 204 via the sensing network 226 using UDP. By processing bursts of compressed data, the embedded tuning system 201 can quickly react to an event in a process step and provide synchronized command and control for the devices 204 in the process module 102. The virtual device 210 provides optimal control/synchronization of all subsystems comprising the devices 204 of the process module 102.

The monitoring of the UDP data stream received from the devices 204 via the sensing network 226 is optimized for high fidelity characterization of individual subsystem behavior above and beyond basic command/control requirements. Specifically, using the UDP data stream, health checks of the subsystems comprising the devices 204 can be performed at microsecond precision while control of the subsystems only requires milliseconds.

Alternatively or additionally, the sensing network 226 can include one or more interfaces other than an Ethernet-based interface. Non-limiting examples of the other interfaces comprise a serial interface (e.g., a universal serial bus or USB). Further, while not shown, the embedded tuning systems 200, 201 can comprise a USB interface that communicates with the tuning code 212 and the processor 214 of the embedded tuning systems 200, 201. Using the USB interface, the embedded tuning systems 200, 201 can indicate an endpoint of a process step to the process controller 208 so that the process controller 208 can advance the process to a next process step or end the process.

Thus, the embedded tuning system 201 can provide on demand tuning in real time. The embedded tuning system 201 can provide low level synchronized command and control for the devices 204 in the process module 102. The virtual device 210 can read/write into the EtherCAT network 206 without requiring additional hardware (i.e., without physically accessing the EtherCAT network 206 using additional hardware as shown in FIGS. 4A, 5A, 6A, 7A, 8A, 9A, 10A, and 11A). The embedded tuning system 201 can achieve efficient load distribution of both data and CPU (processor) cycles to achieve optimal result with the least amount of resources (e.g., processing time and memory). The embedded tuning system 201 can provide high level command and control for the devices 204 in the process module 102 by processing high density bursts of compressed data from the devices 204 to react quickly to a process event and provide low density highly deterministic setpoints to the devices 204. The sensing network 226 of the embedded tuning system 201 is optimized for monitoring the devices 204 by processing compressed data captured by UDP faster than the EtherCAT network 206, where the compressed data is not deterministic but is optimized for tuning purposes.

Using the EtherCAT network 206 and the sensing network 226 in parallel decouples the requirements for processing the input data received from the devices 204 via the EtherCAT network 206 and the high-density bursts data received from the devices 204 via the sensing network 226. Using the EtherCAT network 206 and the sensing network 226 in parallel also allows generating variable payloads for the output data and low-density, highly deterministic setpoints to be output to the devices 204 via the virtual device 210 through the EtherCAT network 206.

For example, in RFG frequency tuning and chamber matching applications (described below), the modulation rate of the individual devices (e.g., the device 204-2 shown in FIG. 11) is on the same order (or faster) than the EtherCAT network 206, which renders EtherCAT samples collected via the EtherCAT network 206 insufficient to describe/characterize the modulation behavior of these devices. Instead, bursts of compressed data received from RF sources via the sensing network 226 allows for maintaining highly deterministic control of the RF sources (e.g., the device 204-2) while inputs from these devices (e.g., the device 204-2) are aggregated and characterized by the processor 214 and the tuning code 212 and outputs (e.g., adjustments to setpoints of the devices 204-2) are generated by the embedded tuning system 201 to be fed back to the devices (e.g., the device 204-2) via the virtual device 210 through the EtherCAT network 206.

The tuning code 212 of the embedded tuning systems 200, 201 is also agnostic to applications used by the external tuning system. Regardless of the application used by the external tuning system, the tuning code 212 of the embedded tuning systems 200, 201 can be used to tune the process as described above. The tuning code 212 can be swapped with another tuning code 212 depending on process requirements without requiring changes to the process control application in the process controller 208 or to an external tuning application as described above. Thus, the tuning code 212 of the embedded tuning systems 200, 201 can plug and play with the process control application in the process controller 208 and the external tuning application.

Further, the user (e.g., the tool operator) can select any of the inputs and outputs of the devices 204 that the virtual device 210 can access and interact with. These features make the virtual device 210 of the embedded tuning systems 200, 201 user-configurable and portable to any tuning application used by the external tuning system. Further, by operating in the network layer and the transport layer of the OSI model, which eliminates communication through the application layer and other higher layers of the OSI model, the embedded tuning systems 200, 201 can tune the process in any step of the process in time periods as short as 1 ms.

Tuning of the process is often performed to achieve expected process results, to recover from error modes, and/or to perform maintenance operations. Some other tuning systems provide different models to implement these different operating modes. However, in these other tuning systems, only a single setpoint can be changed per process step to change a model from one process step to another. These other tuning systems cannot tune a setpoint during a process step and must wait to apply tuning until a next process step or a next substrate is processed. These other tuning systems require stopping the process to upgrade a model.

In contrast, the embedded tuning systems 200, 201 of the present disclosure can swap models used by the tuning code 212 to implement different operating modes in the process module 102 during a process step. Accordingly, in addition to the tuning code 212 being swappable, the embedded tuning systems 200, 201 additionally provides hot-swappable, plug-and-play models that can be used by the tuning code 212 to tune a process step during the process step itself. Non-limiting examples of the models that can switch operating modes comprise models for switching from process mode to tuning mode, tuning mode to process mode, process mode to error recovery mode, error recovery mode to process mode, Tuning mode1 to Tuning mode2 or vice versa, Process mode1 to Process mode2 or vice versa, maintenance mode to process qualification mode, and so on. For example, the embedded tuning systems 200, 201 can tune a parameter of a first model while a second model is in use and can swap a second model with the first tuned model in the same process step in real time. Further, the embedded tuning systems 200, 201 can implement and switch between different models to switch operating modes within the same process step.

### Section 6: Examples of Applications

The embedded tuning systems 200, 201 can be used to tune the process in many applications. Non-limiting examples of the applications comprise RF generator (RFG) frequency tuning, chamber matching (e.g., controlling RF generators and matching circuits used to generate plasma in multiple process modules or processing chambers to achieve process uniformity), direct drive RFG plasma ignition, top plate drift compensation, substrate temperature compensation, tunable edge sheath (TES) compensation, and so on. These examples are summarized below.

For example, in RFG frequency tuning and chamber matching applications, the embedded tuning system 201 can be used to provide real-time feedback control for the device 204-2 via the virtual device 210 to achieve expected process results. RFG frequency tuning comprises control of RFG, RF matching, and RF voltage controller interface (VCI) in the device 204-2. Chamber matching comprises control of RF subsystem used in the devices 204-2 between the processing modules 102 to achieve uniform process results across the process modules 102.

In the RFG frequency tuning and chamber matching applications, the embedded tuning system 201 can be used to control a search of the RFG tuning frequency based on current live data collected from the device 204-2 via the sensing network 226 to decide optimization direction. Tuning within a step can reduce tuning time by tenfold compared to one tuning setpoint per process step. The virtual device 210 can overwrite setpoints of the RF subsystem in the device 204-2 at the EtherCAT master level. The virtual device 210 can provide additional setpoints beyond the process controller 208. The virtual sensor data generated from a virtual model in the tuning code 212 can be parameterized by the processor 214 for transferring optimized setpoints for chamber matching on the tool 100. Further, a search model in the tuning code 212 used to search the RFG tuning frequency can be hot swapped in the embedded tuning system 201. For example, based on an unhealthy behavior of a RF generator and matching circuit detected from live data collected from the device 204-2 via the sensing network 226, and based on one or more unsuccessful tuning decisions provided by a tuning model1, the embedded tuning system 201 can change the tuning model from tuning model1 to tuning model2. The tuning model needs to be changed since there are multiple tuning scenarios based on plasma regimes and substrate conditions that are unknown to the process controller 208 but are known to the embedded tuning system 201 based on the data captured from the devices 204 via the sensing network 226.

In the direct drive RFG plasma ignition application, the embedded tuning systems 200, 201 can be used to control plasma sources (e.g., transformer coupled plasma or TCP sources in the devices 204-2) to achieve matching plasma ignition trajectories across the process modules 102 for achieving uniform process results. For example, the embedded tuning systems 200, 201 can be used to provide closed loop control of RF power supplied to the plasma source (e.g., in the device 204-2) to generate the plasma 114 to control plasma ignition trajectories for chamber-to-chamber repeatability and to achieve process uniformity across the process modules 102.

In the top plate drift compensation application, where heat conducted by the top plate can cause temperature drift in some of the components such as an RF electrode (e.g., the showerhead 112 shown in FIG. 2) of the process module 102, the embedded tuning systems 200, 201 can be used to control setpoints for heating, cooling, and RF generator devices including matching circuits (e.g., in devices 204-2, 204-3 shown in FIG. 11). The embedded tuning systems 200, 201 can be used to control these setpoints across a mean time between cleaning (MTBC) cycle to achieve uniform process results although the components in the respective devices may be eroded, worn, and/or drifting in temperature control. For example, the embedded tuning systems 200, 201 can be used to provide a closed loop control of temperature drift in an RF electrode (e.g., in the device 204-2) especially when the RF power to the RF electrode is turned off.

In the substrate temperature compensation application, the embedded tuning systems 200, 201 can be used to control setpoints for heating, cooling, and gas flow control devices across an MTBC cycle to achieve uniform process results although the components in the respective devices may be clogged, worn, eroded, and/or drifting in their respective controls. For example, the embedded tuning systems 200, 201 can be used to provide a closed loop control of backside gas flow (e.g., by controlling the device 204-1 shown in FIG. 11) in a substrate support 110 such as an electrostatic chuck (ESC).

In the TES compensation application, the embedded tuning systems 200, 201 can be used to control TES RF subsystem between process modules 102 and across an MTBC cycle to achieve uniform process results although the components in the respective devices may be worn and/or drifting in their respective controls (e.g., of both RF and temperature). For example, the embedded tuning systems 200, 201 can provide a closed loop control of RF setpoint of the TES RF subsystem based on RF power used to generate plasma (e.g., by controlling devices 204-2, 204-4 shown in FIG. 11).

### Section 7: Methods for Process Tuning

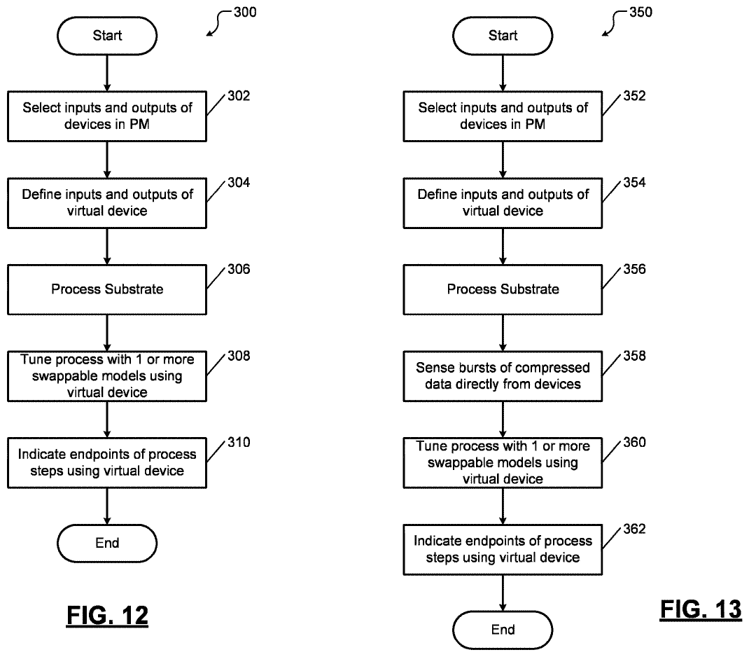

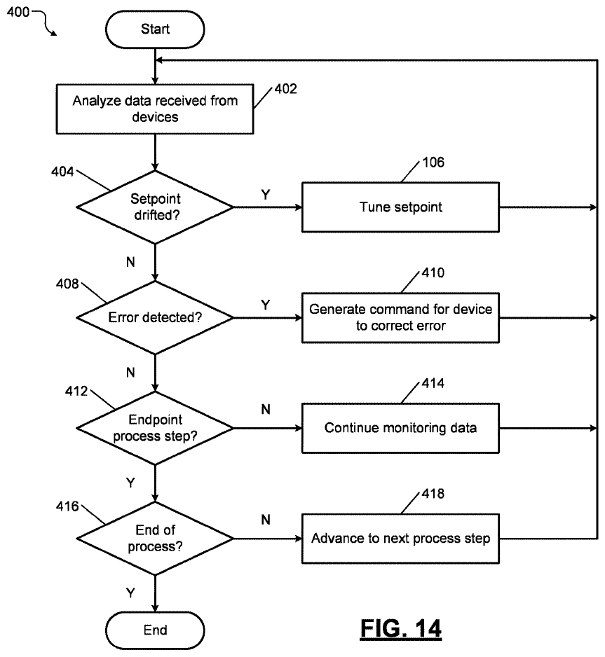

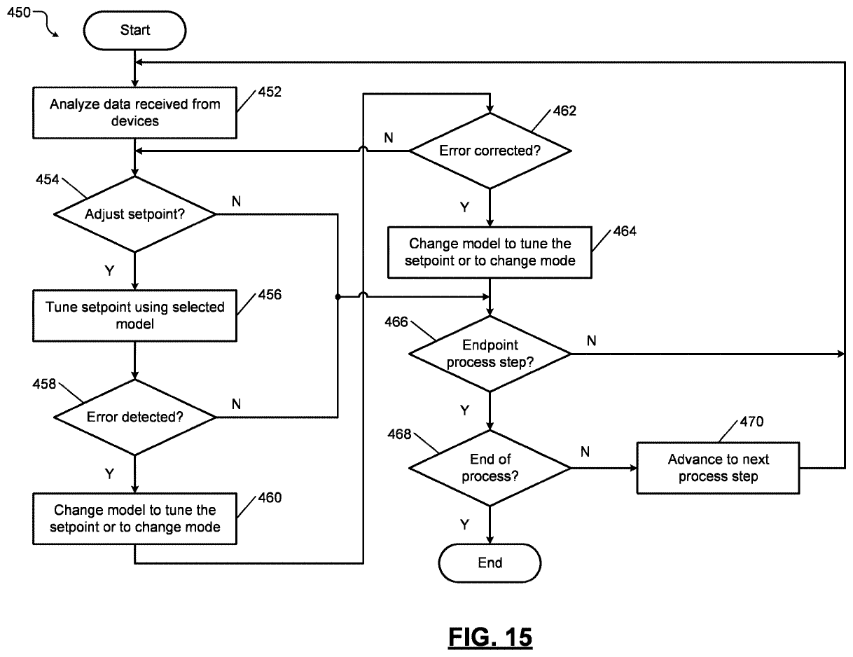

FIGS. 12-15 show methods of tuning a process in the process module 102. The methods can be performed by the embedded tuning systems 200, 201. For example, the processor 214, the tuning code 212, and the virtual device 210 can perform these methods. FIG. 12 shows a method of defining and using the virtual device 210 to tune the process. FIG. 13 shows a method of tuning the process using the sensing network 226 and swappable models. FIG. 14 shows a method of tuning a process step in detail. FIG. 15 shows a method of swapping tuning models in the tuning code 212. These methods are described below in detail.

FIG. 12 shows a method 300 method performed by the embedded tuning systems 200, 201 for defining and using the virtual device 210 to tune a process in the process module 102. At 302, the inputs and outputs of the device 204 that are used for tuning the process are selected. As described above, these inputs and outputs are user-selectable based on the process being performed in the process module 102. For example, a tool operator can select these inputs and outputs from a GUI provided by the process controller 201 of the process module 102 or the system controller 104 of the tool 100.

At 304, the method 300 (e.g., the tuning code 212 and/or the processor 214) defines the inputs and outputs of the virtual device 210 based on the selected inputs and outputs. As described above, the virtual device 210 is thus configurable for a given process being performed in the process module 102. At 306, the process controller 208 begins processing the substrate 116 in the process module 102 using a process recipe.

At 308, the method 300 tunes the process with one or more swappable models using the virtual device 210. For example, the embedded tuning systems 200, 201 receive data from the devices 204 for the selected inputs via the EtherCAT network 206 and/or the sensing network 226. The tuning code 212 generates adjustments to one or more setpoints of one or more of the devices 204 using one or more swappable models. The virtual device 210 outputs the adjustments to change the setpoints of one or more of the devices 204 using the selected outputs via the EtherCAT network 206 (e.g., through a frame sent to the devices 204 by the master device 202 via the EtherCAT network 206).

At 310, the method 300 indicates endpoints of the process steps to the process controller 208 using the virtual device 210 so that the process controller 208 can advance the process to the next process step or end the process. For example, in the embedded tuning system 200, the virtual device 210 can indicate the endpoints of the process steps to the process controller 208 directly or via the master device 202. In the embedded tuning system 201, the virtual device 210 can indicate the endpoints of the process steps to the process controller 208 via a serial interface such as USB of the embedded tuning system 201.

FIG. 13 shows a method 300 performed by the embedded tuning system 201 for tuning the process in the process module 102 using the sensing network 226 and swappable models used in the tuning code 212. Steps 352, 354, and 356 of the method 350 are similar to the steps 302, 304, and 306 of the method 300 and are therefore no described again for brevity.

At 358, the method 350 senses bursts of compressed data from the devices 204 via the sensing network 226. For example, the embedded tuning system 201 (e.g., the processor 214) receives bursts of compressed data from the devices 204 for the selected inputs via the sensing network 226. At 360, the tuning code 212 analyzes the data and generates adjustments to one or more setpoints of one or more of the devices 204 using one or more swappable models to tune the process. For example, the virtual device 210 outputs the adjustments to change the setpoints of one or more of the devices 204 using the selected outputs via the EtherCAT network 206 (e.g., through a frame sent to the devices 204 by the master device 202 via the EtherCAT network 206) to tune the process.

At 362, the method 300 indicates endpoints of the process steps to the process controller 208 using the virtual device 210 so that the process controller 208 can advance the process to the next process step or end the process. For example, the virtual device 210 can indicate the endpoints of the process steps to the process controller 208 via a serial interface such as USB of the embedded tuning system 201.

FIG. 14 shows a method 400 performed by the embedded tuning systems 200, 201 for tuning a process step of the process in the process module 102 in further detail. At 402, in a process step of the process, the tuning code 212 and/or the processor 214 analyzes the data received for selected inputs from the devices 204. For example, in the embedded tuning system 200, the data is received from the devices 204 via the EtherCAT network 206; and in the embedded tuning system 201, additional data is received from the devices 204 via the sensing network 226 as described above.

At 404, based on the analysis, the tuning code 212 determines if a setpoint of a device 204 has drifted. If the setpoint has drifted, at 406, the tuning code 212 tunes (i.e., adjusts) the setpoint of the device 204 as described above, and the method 400 returns to 402.

If the setpoint has not drifted, at 408, based on the analysis, the tuning code 212 determines if an error occurred during the process step. If an error is detected during the process step, at 410, the tuning code 212 generates a command for the device 204 to correct the error. For example, the virtual device 210 communicates the command to the device in a frame sent by the master device 202 to the device 204 via the EtherCAT network 206, and the method 400 returns to 402.

If an error is not detected during the process step, at 412, based on the analysis, the tuning code 212 determines if an endpoint of the process step is reached. If an endpoint of the process step is not reached, at 414, the method 400 continues to monitor the data from the devices 204, and the method 400 returns to 402.

If an endpoint of the process step is reached, at 416, the tuning code 212 determines if the process has ended (e.g., completed). If the process has not ended, at 418, the process controller 208 advances the process to a next step, and the method 400 returns to 402. If the process has ended, the method 400 ends.

FIG. 15 shows a method 450 performed by the embedded tuning systems 200, 201 for swapping tuning models in the tuning code 212 during a process step of the process in the process module 102. Step 452 of the method 450 is similar to step 402 of the method 450 and is therefore no described again for brevity.

At 454, based on the analysis, the tuning code 212 determines if a setpoint of a device 204 has drifted. The method 450 proceeds to 466 if the setpoint has not drifted. If the setpoint has drifted, at 456, the tuning code 212 tunes (i.e., adjusts) the setpoint of the device 204 using a selected model (e.g., a first model) as described above. At 458, the tuning code 212 determines if an error occurred during the process step. The method 450 proceeds to 466 if an error is not detected during the process step. If an error is detected during the process step, at 460, the tuning code 212 swaps the selected model with another model (e.g., a second model) to tune (i.e., adjusts) the setpoint of the device 204 or to change operating mode as described above.

At 462, the tuning code 212 determines if an error occurred during the process step. If an error is not detected during the process step, the method 450 returns to 454. If an error is detected during the process step, at 464, the tuning code 212 again swaps the selected model (e.g., the second model) with another model (e.g., a third model) to tune (i.e., adjusts) the setpoint of the device 204 or to change operating mode as described above, and the method 450 proceeds to 466.

At 466, the tuning code 212 determines if an endpoint of the process step is reached. The method 450 returns to 452 if an endpoint of the process step is not reached. If an endpoint of the process step is reached, at 468, the tuning code 212 determines if the process has ended (e.g., completed). If the process has not ended, at 470, the process controller 208 advances the process to a next step, and the method 450 returns to 452. If the process has ended, the method 450 ends.

The devices and applications are not limited to the examples described above. The embedded tuning systems 200, 201 can tune setpoints and parameters of any device associated with the process module 102 that need to be controlled to perform a process during any step of the process using the methods described above.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

It should be understood that one or more steps within a method may be executed in different order (or concurrently) without altering the principles of the present disclosure. Further, although each of the examples is described above as having certain features, any one or more of those features described with respect to any one of the examples of the disclosure can be implemented in and/or combined with features of any of the other examples, even if that combination is not explicitly described. In other words, the described examples are not mutually exclusive, and permutations of one or more examples with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In some implementations, a controller is part of a system, which may be part of the above-described examples. Such systems can comprise semiconductor processing equipment, including a processing tool or tools, chamber or chambers, a platform or platforms for processing, and/or specific processing components (a wafer pedestal, a gas flow system, etc.). These systems may be integrated with electronics for controlling their operation before, during, and after processing of a semiconductor wafer or substrate.

The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software).

Program instructions may be instructions communicated to the controller in the form of various individual settings (or program files), defining operational parameters for carrying out a particular process on or for a semiconductor wafer or to a system. The operational parameters may, in some examples, be part of a recipe defined by process engineers to accomplish one or more processing steps during the fabrication of one or more layers, materials, metals, oxides, silicon, silicon dioxide, surfaces, circuits, and/or dies of a wafer.

The controller, in some implementations, may be a part of or coupled to a computer that is integrated with the system, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process.

In some examples, a remote computer (e.g., a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control.

Thus, as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor wafers.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

What is claimed is:

1. A system for tuning a process performed on a substrate in a process module of a substrate processing system, the system comprising:
a first controller connected to the process module of the substrate processing system, wherein the first controller is configured to provide steps to perform the process on the substrate in the process module;
a plurality of devices of the process module connected to a first network associated with the process module, the plurality of devices configured to perform operations associated with the process; and
a second controller connected to the process module, the second controller comprising:
an interface configured to receive selected inputs from the plurality of devices via the first network and to provide selected outputs to the plurality of devices via the first network to tune the process, wherein the selected inputs are indicative of the operations of the plurality of devices; and
a processor configured to execute instructions to define the interface, process the selected inputs received during a step of the process, and generate the selected outputs based on the processed selected inputs to adjust one or more of the operations of one or more of the plurality of devices to tune the process during the step of the process.

2. The system of claim 1 wherein the first controller is configured to provide a graphical user interface to select the inputs and outputs of the interface.

3. The system of claim 1 wherein:
the first controller is configured to execute a first application or a second application to provide the steps to perform the process on the substrate in the process module; and
the instructions executed by the processor of the second controller to tune the process during the step of the process is independent of the first and second applications.

4. The system of claim 1 wherein:
the instructions comprise a first set of instructions and a second set of instructions; and
the processor of the second controller is configured to execute the first and second sets of instructions interchangeably to tune the process during the step of the process.

5. The system of claim 1 wherein:
the first controller is configured to execute an application to provide the steps to perform the process on the substrate in the process module; and
the second controller is configured to swap the instructions with another set of instructions to tune the process during the step of the process while the first controller executes the application unchanged.

6. The system of claim 1 further comprising a master device connected to the first controller and the first network, the master device configured to:
receive the selected inputs via the first network;
receive the selected outputs from the interface; and
transmit the selected outputs to the plurality of devices via the first network.

7. The system of claim 6 wherein:
the master device comprises a physical layer and a data link layer of the Open Systems Interconnection (OSI) model; and
the processor of the second controller is configured to execute the instructions in a network layer of the OSI model.

8. The system of claim 7 wherein:
the first controller is configured to execute an application in an application layer of the OSI model to provide the steps to perform the process; and
the processor of the second controller does not execute the instructions in the application layer.

9. The system of claim 1 wherein:
the plurality of devices comprises sensors and actuators associated with the process module;
the sensors are configured to sense parameters associated with the process; and
the actuators are configured to perform the operations associated with the process.

10. The system of claim 1 wherein the instructions comprise a plurality of models for tuning the process, and when the instructions are executed by the processor of the second controller, the second controller is configured to:
adjust the one or more of the operations of the one or more of the plurality of devices using a first model of the plurality of models during the step of the process;
receive from the plurality of devices, after the adjustment, a second set of the selected inputs via the first network during the step of the process, the second set of the selected inputs is indicative of the operations of the plurality of devices after the adjustment; and
adjust, based on the second set of the selected inputs, the one or more of the operations of the one or more of the plurality of devices using a second model of the plurality of models during the step of the process.

11. The system of claim 1 wherein:
the processor of the second controller is configured to communicate an endpoint of the step of the process to the first controller via the interface; and
the first controller is configured to advance the process to a next step of the process or end the process in response to the communicated endpoint.

12. The system of claim 1 wherein:
the second controller comprises a second interface;
the processor of the second controller is configured to communicate an endpoint of the step of the process to the first controller via the serial interface; and
the first controller is configured to advance the process to a next step of the process or end the process in response to the communicated endpoint.

13. The system of claim 12 wherein the second interface comprises a serial interface.

14. The system of claim 12 wherein the second interface comprises a universal serial bus (USB) interface.

15. The system of claim 1 further comprising a second network, wherein:
the second controller and the plurality of devices are connected to the second network; and
the processor of the second controller is configured to receive additional data from the plurality of devices via the second network, process the additional data, and generate the selected outputs based on the processed additional data.

16. The system of claim 15 wherein the processor of the second controller is configured to receive the additional data comprising bursts of compressed data from the plurality of devices via a User Datagram Protocol (UDP) of a transport layer of the Open Systems Interconnection (OSI) model.

17. The system of claim 15 wherein the instructions comprise a plurality of models for tuning the process, and when the instructions are executed by the processor of the second controller, the second controller is configured to:
adjust the one or more of the operations of the one or more of the plurality of devices using a first model of the plurality of models during the step of the process;
receive from the plurality of devices, after the adjustment, a second set of the selected inputs via the first network and a second set of the additional data via the second network during the step of the process, the second sets of the selected inputs and the additional data indicative of the operations of the plurality of devices after the adjustment; and
adjust, based on the second sets of the selected inputs and the additional data, the one or more of the operations of the one or more of the plurality of devices using a second model of the plurality of models during the step of the process.

18. The system of claim 15 wherein the interface comprises a physical layer and a data link layer of the Open Systems Interconnection (OSI) model and wherein the processor of the second controller is configured to execute a first portion of the instructions associated with the first network in a network layer of the OSI model and a second portion of the instructions associated with the second network in a transport layer of the OSI model.

19. The system of claim 15 wherein:
one of the plurality of devices comprises a radio frequency (RF) power source and a matching circuit configured to supply RF power to the process module to generate plasma in the process module during the process; and
one of the selected outputs adjusts a frequency of the RF power source to adjust a profile of the plasma during the step of the process.

20. The system of claim 15 wherein:
one of the plurality of devices comprises a radio frequency (RF) power source and a matching circuit configured to supply RF power to the process module to generate plasma in the process module during the process; and
one of the selected outputs adjusts a frequency of the RF power source to adjust a profile of the plasma during the step of the process and to match the frequency in a second process module of the substrate processing system during the step of the process performed in the second process module.

21. The system of claim 1 wherein:
one of the plurality of devices comprises a temperature control device configured to control a temperature of a component of the process module during the step of the process; and
one of the selected outputs adjusts the temperature of the component during the step of the process.

22. The system of claim 21 wherein:
the temperature control device comprises a temperature controller, one or more heaters disposed in at least one of a substrate support and a showerhead of the process module, and one or more cooling channels disposed in at least one of the substrate support and the showerhead of the process module; and
the component comprises at least one of the substrate support and the showerhead of the process module.

23. The system of claim 1 wherein:
one of the plurality of devices comprises a mass flow controller configured to control a flow rate of a gas supplied to the process module during the process; and
one of the selected outputs adjusts the flow rate of the gas during the step of the process.

24. The system of claim 1 wherein:
one of the plurality of devices comprises a pressure controller configured to control a pressure of a gas supplied to the process module during the process; and
one of the selected outputs adjusts the pressure of the gas during the step of the process.

25. The system of claim 1 wherein:
one of the plurality of devices comprises a tunable edge ring system configured to adjust a shape of plasma around edges of the substrate during the process; and
one of the selected outputs adjusts the tunable edge ring system during the step of the process.

26. The system of claim 25 wherein adjusting the tunable edge ring system comprises adjusting an actuator associated with the tunable edge ring system, adjusting a radio frequency power supplied to the tunable edge ring system, or both.

27. The system of claim 25 wherein adjusting the tunable edge ring system comprises adjusting a radio frequency (RF) power supplied to the tunable edge ring system based on RF power supplied to the process module to generate the plasma in the process module during the process.

28. The system of claim 1 wherein the first and second controllers are implemented by first and second processor cores, respectively.
